(19) United States
(12) Patent Application Publication
(10) Pub. No.: US 2024/0306688 A1
(43) Pub. Date: Sep. 19, 2024

(54) METHOD OF MITIGATING OFF-ODORS

(71) Applicant: GIVAUDAN SA, VERNIER (CH)

(72) Inventors: Yohei MIYAMOTO, Tokyo (JP); Chisato MAYAMA, Tokyo (JP); Bernard KRANEN, Singapore (SG)

(21) Appl. No.: 18/681,639

(22) PCT Filed: Aug. 3, 2022
(86) PCT No.: PCT/EP2022/071794

§ 371 Date: Feb. 6, 2024

Related U.S. Application Data
(60) Provisional application No. 63/236,067, filed on Aug. 23, 2021.

(51) Int. Cl. A23L 27/00; A23C 9/13; A23C 13/12; A23L 2/02; A23L 2/56; A23L 5/20; A23L 27/20

(52) U.S. Cl. CPC A23L 27/84; A23C 9/1307; A23C 13/12; A23L 2/02; A23L 2/56; A23L 5/27; A23L 27/2026; A23L 27/2028; A23L 27/204; A23L 27/2052

(57) ABSTRACT

The present disclosure relates to a method for mitigating off-odors in food and beverages. to flavor composition mitigating off-odors in food and beverages and to the use of specific flavor ingredients to mitigate off-odors in food and beverages.

### FIELD OF THE INVENTION

The present disclosure relates to a method for mitigating off-odors in food and beverages, to flavor composition mitigating off-odors in food and beverages and to the use of specific flavor ingredients to mitigate off-odors in food and beverages.

### BACKGROUND OF THE INVENTION

The formation of off-odor in food and beverage products is a highly undesired phenomenon. Off-odors may originate from a variety of causes. An off-odor may be intrinsic to an ingredient present in the recipe of the food or beverage product, such as garlic-derived compounds or Japanese turmeric-derived compounds. More often, the off-odor may appear on aging the product, for example during storage, under the action of heat or light. Typical examples of off-odor are those formed by the oxidation of fish oil, citrus terpenes, and neutral spirits, or by the hydrolysis of low molecular weight esters.

AU 2001/259534 B2 discloses a process for removing soluble off-flavors and off-odors from food or beverage products comprising contacting the food or beverage with one or more aliphatic synthetic polymer. Such a process is not suitable for preventing the formation of malodor over time.

U.S. Pat. No. 4,961,939 A discloses deodorized fish oil-containing food products stabilized by enzymes, such as aldehyde dehydrogenase, aldehyde oxidase, alcohol dehydrogenase and alcohol oxidase. Such enzymes may alter the taste of most foods and beverages and therefore may not be used universally in these products.

CA 2 294 458 C discloses citral-containing citrus beverages comprising a water soluble plant extract comprising caffeic acid as a stabilizer. The plant extracts include, for example, rosemary extract, Mentha extract, Origanum extract and Salvia extracts. Such extracts may also alter the taste of most foods and beverages and therefore may not be used universally in these products. The use of other anti-oxidants such as citric acid/potassium citrate acid base conjugate is to suppress the deterioration of lemon flavor is mentioned in JP 2007/039610 A. However, using such acid base conjugate requires lowering the pH of the product. Furthermore, the addition of citric acid may also twist the taste of non-citrus product.

US 2008/0317929 A1 discloses a method of removing off-flavors in alcoholic beverages comprising the steps of providing an alcoholic beverage in a sealable container, providing a closure comprising a liner made of a polymer and a fatty acid sulfur scavenger, sealing the sealable container with the closure. Such a method is specific to sulfur-containing malodor compounds.

There is therefore a need for a method for mitigating off-odors in food and beverages that do not have the drawbacks of the prior art. In particular, the method should be universally applicable to food and beverages, while still having a minimal impact on the taste, and more generally on the hedonic profile of these products.

### SUMMARY OF THE INVENTION

In one illustrative embodiment, a method for mitigating off-odors in flavored food or beverage products comprises the steps of:
a) identifying the one or more off-odor components Oᵢ:
b) calculating the clogP of the one or more off-odor components Oi, (clogP(Oᵢ)):
c) for each of the one or more off-odor component Oᵢ identified in step a), adding to the flavored food or beverage product an effective amount of at least one flavor ingredient Fᵢⱼ having clogP(Fᵢⱼ) value(s) equal to clogP(Oᵢ)±0.75 clogP unit, more particularly clogP(Oᵢ)±0.5 clogP unit:
wherein, clogP(Oᵢ) and clogP(Fᵢⱼ) are the calculated octanol/water partition coefficient of both off-odor component Oᵢ and flavor ingredient Fⱼ: and
wherein the effective amount at least one flavor ingredient Fᵢⱼ is from 0.000001 wt.-% to 100 wt.-%, more particularly from 0.00001 wt.-% to 10 wt.-%, still more particularly from 0.00005 wt.-% to 2.5 wt.-%, based on the total weight of the odor active flavor ingredients present in the flavored food or beverage product.

In a second aspect, the present disclosure provides a food or beverage product selected from savory products, dairy products, beverages, carbonated beverages, and energy drinks, obtainable by the method according to the present disclosure.

In a third aspect, the present disclosure provides a flavor composition comprising at least one flavor ingredients Fᵢⱼ having the features disclosed hereinabove.

In a fourth aspect, the present disclosure provides the use of at least one selected flavor ingredient Fᵢⱼ to mitigate off-odors caused by one or more off-odor components Oᵢ, the clogP value of the at least one selected flavor ingredient Fᵢⱼ, (clogP(Fᵢⱼ)), being close to that of the one or more off odor component Oᵢ, (clogP(Oᵢ)) by less than 0.75, more particularly less than 0.5 clogP unit.

### DETAILED DESCRIPTION OF THE INVENTION

In addressing the deficiencies in the prior art the applicant surprisingly found that it was possible to construct flavor compositions that exhibit mitigating off-notes perception in food and beverages without altering the overall quality of these product, said flavors being constructed by adding to the flavor, an effective amount of at least one flavor ingredients having calculated octanol-water partition coefficient that are close to the calculated octanol-water partition coefficients of the off-odor components.

Under “off-odor” is meant an odor that may be perceived by the consumer as an alteration of the odor this consumer would expect from a given product. Typically, the off-odor may be unusual, unpleasant or even repealing. For example, typical off-odor may be encountered in product containing oxidation products of fish oil, such as cis-4-heptenal, trans-2-heptenal, cis-1,5-octadien-3-ol and cis-1-octen-3-ol: in products containing oxidation and cyclisation products of citral, such as p-methylacetophenone: in products containing pungent garlic components, such as diallyl disulfide, allyl mercaptan, allyl methyl disulfide, and allyl methyl sulfide: in products containing pungent turmeric components, such as turmerones and vinylguaiacol: in cheap neutral spirits containing thermal degradation products, such as monoterpenes: or in milk and diary products containing degradation products, such as short chain C2 to C6 carboxylic acids.

The identification of the one or more off-odor components may be performed by applying analytical method known to the art. More particularly, the off-odor components are volatile and may be extracted from the gas phase (or “headspace”) surrounding samples. The headspace may be in equilibrium with the sample, or not. The extraction may be conducted by contacting the headspace with an adsorbent which may be extracted with a solvent or desorbed thermally. The components may then be separated by gas-liquid chromatography and identified based on their retention times and mass spectra in a gas chromatograph equipped with a mass spectrum detector.

Under “clogP” is meant the calculated octanol/water partition coefficient. The octanol/water partition coefficient is a well-known and popular physicochemical parameter that has been found to correlate well with the so-called bioavailability of some drugs in the human body, the persistency of chemicals in the environment and the deposition of fragrances on various substrates, such as fabrics and hair. This octanol/water partition coefficient may be measured experimentally by different methods known to the art. However, the experimental determination of this parameter is often difficult, time consuming and inaccurate, in particular for substances having logP values lower than 0.01 and higher than 3, due to analytical errors. Therefore, calculation methods have been developed, which use chemical group contributions obtained from quantitative structure-property relationships based on very large experimental data sets.

The calculated logP is called clogP or ClogP, wherein the nomenclature ClogP is preferably used for values calculated using the original calculation method developed at Pomona college, which have then be commercialized by BioByte, Inc. of Claremont, CA. and Daylight Chemical Information Systems, Inc. of Aliso Viejo, CA. The clogP calculation software implemented in Perkin-Elmer ChemDraw software provides clogP values that are almost identical to those of Daylight, with a deviation of ±0.06 ClogP units at most, except for conjugated ketones, where the deviation may reach ±0.2 ClogP unit. ChemDraw is part of the ChemOffice platform. Conversely, ACD/LogP values, calculated by using ACD labs software, or LOGP, calculated by using the Chemical Computing Group Molecular Operative Environment (MOE) software deviate significantly from the preceding ones.

In the context of the present invention, the clogP values of both off-odor and flavor components are preferably calculated by using the ClogP calculation method implemented in ChemDraw versions 1 to 18. Relevant clogP values are listed herein under.

Once an off-odor component has been identified, its two-dimensional chemical structure is drawn on a ChemDraw document and its clogP value is read on the “Chemical Properties” panel. Note that the clogP value must not be confused with the “Log P” value that also appears on the Chemical Properties panel of ChemDraw. This latter value is obtained from a different (ChemPro) code also implemented in ChemDraw and is not used in the context of the present invention.

Once the clogP of an off-odor component Oᵢ (clogP(Oᵢ)) has been obtained, the next step is to add a flavor ingredient having a clogP value (clogP(Fᵢⱼ)) close to that of the off-odor component. The “Oᵢ” nomenclature is used to design the off-odor component i. The “Fᵢⱼ” nomenclature is used to design a flavor ingredient selected for counteracting the off-odor component i.

Such a flavor ingredient is also referred to as “off-odor counteracting flavor ingredient” hereinafter.

For each off-odor component there may be N counteracting flavor ingredients, numbered 1 to N. Thus, for instance, if three counteracting flavor ingredients are used to counteract off-odor component i=1, then these three (N=3) counteracting flavor ingredients will be written F₁₁, F₁₂ and F₁₃.

In particular embodiments, N is not higher than 5, more particularly not higher than 3, and still more particularly not higher than 2.

Similarly, one flavor ingredients may be used to counteract more than one off-odor component. For instance, if a single flavor ingredient, say Fil, has good counteracting effect against three off-odor components i=1, 2 and 3, then the following formal equality is applied: F₁₁₌F₂₁₌F₃₁.

Two clogP values are said to be “close to” each other if the difference between these clogP values is 1 clogP unit or less.

In particular embodiments, the difference between clogP(Fᵢⱼ) and clogP(Oᵢ) is 0.75 or less, more particularly 0.5 or less.

Once, the at least one flavor ingredient Fᵢⱼ has been identified, it is added to the product at an effective amount. The determination of the amount at which a given flavor ingredient counteracts effectively a given off-note is empirical and constitutes a straightforward step for the skilled person.

By “effective amount” is meant the quantity of a given flavor ingredient Fᵢⱼ that is sufficient to decrease or suppress the perception of the off-odor component Oᵢ.

In particular embodiments, the effective amount of the flavor ingredient Fᵢⱼ is from 0.000001 wt.-% to 100 wt.-%, more particularly from 0.00001 wt.-% to 10 wt.-%, still more particularly from 0.00005 wt.-% to 2.5 wt.-%, based on the total weight of the odor active flavor ingredients present in the flavored food or beverage product.

If a particular flavor ingredient Fᵢⱼ is already present in the flavored food or beverage product, but its level is not effective enough for the sake of the present disclosure, then the level of this ingredient may be increased, so that the total amount of the ingredient is effective.

The flavor ingredient Fᵢⱼ is typically admixed with other flavor ingredients known to the art, such as plant oils and extracts and chemical molecules having a molecular weight of typically less than 250 g/mol, such as for example aldehydes, esters, alcohols, phenols, ethers, pyrazines, thiazols, mercaptans, sulfides, and acids.

Reference herein to “odor active flavor ingredients” is to be taken as reference to any flavor ingredient that is not a solvent, an emulsifier, an inorganic salt, a carbohydrate, a modified carbohydrate, a sugar alcohol, a yeast or a protein.

Reference herein to the wt.-% of a flavor ingredient is to be taken as reference to the concentration of a flavor ingredient based on the total amount of odor active flavor ingredients contained in a product. If a flavor composition contains other non-flavor or technical ingredients, such as oils, solvents, solubilizers, stabilizers, and the like, then the amount of these ingredients present is not to be taken into account when determining the wt % of flavor ingredients. Oils that are not taken into account in the calculation of the percentage by weight include vegetable oils and vegetable oils fractions, more particularly triglyderides. Solvents that are not taken into account in the calculation of the percentage (%) by weight include water, glycerol, ethanol, 1-propanol. Isopropanol (2-propanol), propylene glycol (propane-1,2-diol), triethyl citrate (triethyl 2-hydroxypropane-1,2,3-tricarboxylate), tributyl citrate (2-hydroxy-1,2,3-propanetricarboxylic acid tributyl ester), triacetin (1,2,3-propanetriol triacetate), diacetin (1,2,3-propanetriol diacetate), medium chain triglycerides, and vegetable oils. Stabilizers that are not taken into account in the calculation of percentage (%) by weight include butyl hydroxyl toluene (2,6-ditert-butyl-4-methylphenol): tocopherols: and the like.

Solubilizers that are not taken into account in the calculation of the percentage (%) by weight of flavor ingredients include surfactants, such as gum lecithins, glycolipids, saponins, polysorbates and sorbitol esters.

Inorganic salts, carbohydrates, such as sugars, dextrins, maltodextrins, acacia gum, and modified carbohydrates, such as modified starch, sugar alcohols, yeasts and proteins are not taken into account in the calculation of the percentage by weight of flavor ingredients.

Suitable ingredient Fᵢⱼ having a clogP(Fᵢⱼ) value from −1 to 0.5 may include acetyl propionyl (2,3-pentanedione) (ClogP =−0).84): gamma butyrolactone (clogP =−0).8): diethyl tartrate (clogP =−0.69): formic acid (clogP =−054): 2,3-hexanedione (clogP =−0).31): 3,4-hexanedione (clogP =−0).31): valerolactone gamma (clogP =−0).28): valerolactone delta (-0).24): acetaldehyde (clogP =−0).22): acetoin (clogP =−0).2): tetrahydrofurfuryl alcohol (clogP =−0).12): 2-(hydroxyacetyl)furan (clogP=0.08): 2-acetylpyrazine (clogP =−0.08): maltol (clogP=0.1): sulfurol (clogP=0.13): ethyl pyruvate (clogP=0.16): methyl acetate (clogP=0).18): angelica lactone alpha (5-methyl-3H-furan-2-one) (clogP-( )2): 2,3-heptanedione (clogP=0).22): 2-methyltetrahydrofuran-3-one (clogP=0.24): ethyl formate (clogP=0.26): hexalactone delta (clogP=0).27): furfuryl alcohol (clogP=0.28): propanal (clogP=0).3): butan-2-one (clogP=0.32): propionic acid (clogP=0.33): ethyl lactate (clogP=0.33): ethyl acetoacetate (clogP=0.33): propionic acid (ClogP=0.34): ethyl 3-hydroxy butyrate (clogP=0).37): corylone dried (clogP=0.42): 2-acetyl-3-methylpyrazine (clogP=0.42): dimethyl succinate (clogP=0.42): 3-acetylpyridine (clogP=0.48): and hexalactone gamma (clogP=0.48).

Suitable ingredient Fᵢⱼ having a clogP(Fᵢⱼ) value from 0.51 to 1.5 may include 1-penten-3-one (clogP=0).52): pent-3-en-2-one (clogP=0.52): methyl-2-pyrrolyl ketone (clogP=0.59); butanol (clogP=0.6): 4-hydroxy-5-methyl-3(2h)-furanone (clogP=0.61): 3,4-dimethylcyclopentane-1,2-dione (clogP=0.62): 1,2-dimethyl-3,5-cyclopentadione (clogP=0.62): ethyl maltol (clogP=0.63); isobutyric acid (clogP=0.64): 3-hydroxy butanoic acid (clogp=0.64): dimethyl-2,3 pyrazine (clogP=0.66): ethyl levulinate (clogP=0.66): furfural (clogP=0.67): acetyl-2 thiazole (clogP=0.71): methyl propionate (clogP=0).71): ethyl acetate (clogP=0.71); methyl butenol (clogP=0.72): isobutyl alcohol (clogP=0).74): isobutyraldehyde (clogP=0).74): tetrahydrofurfuryl acetate (clogP=0.74): 2-acetylfuran (ClogP=0.76): methyl nicotinate (clogP=0.77): heptalactone gamma (clogP=( )77): butyraldehyde (clogP=0).83): pentan-2-one (clogP=0).85): butyric acid (clogP=0.86): ethyl-3-hydroxy-4-methyl-2(5h)-furanone (clogP=0).86): penten-1-ol, 3-cis (clogP=0.87): acetyl-2 pyridine (clogP=0.88): 4-pentenal (clogP=0.88): (E)-2-butenoic acid (clogP=0.89): methyl-3-hydroxyhexanoate (clogP=0.89): 4-pentenoic acid (clogP=0.91): 3-methyl-2-butenal (clogP=0.92): methyl-2 butene-2-ol-4 (prenol) (clogP=0.93): piperidine (clogP=0).93): prenol (clogP=0.94): 2-acetyl-3-ethylpyrazine (clogP=0.95); isoamyl alcohol (clogP=1): 4-hydroxy-3.5-dimethoxy-benzaldehyde (clogP=1.01): methyl isobutyrate (clogP=1.02): anisyl alcohol (clogP=1.02): dimethyl-2.5 pyrazine (clogP=1.03): 2.6.6-trimethylcyclohex-2-ene-1.4-dione (clogP=1.03): 4-hexen-3-one (clogP=1.04): 3-ethyl-2-hydroxy-2-cyclopenten-1-one (clogP=1.07): 1-phenyl-1.2-propanedione (clogP=1.07): zingerone (clogP=1.07): 2-acetyl-3.5-dimethylpyrazine (clogP=1.1): benzyl alcohol (clogP=1.1): 2.6-dimethoxyphenol (clogP=1.11): trimethyl pyrazine (clogP=1.11): 2-methylbutyric acid (clogP=1.13): diethyl malonate (clogP=1.13): aldemax (1.2-bis(1-ethoxyethoxy)propane) (clogP=1.13): furonol (clogP=1.13) :: pentanol-2 (clogP=1.13): methoxy methyl pyrazine (clogP=1.14): furfuryl acetate (clogP=1.14): 2.methylbutyric acid (ClogP=1.17): 5-methyl-furfural (clogP=1.17) :: 2-methyl-butan-1-ol (clogP=1.2): 2-ethyl 5.6 methyl pyrazine (clogP=1.22): ethyl-2 methyl-5 pyrazine (clogP=1.22): methyl-2 butanol (clogP=1.22): raspberry ketone (clogP=1.22): 4-methylpent-2-enoic acid (clogP=1.22): ethyl propionate (clogP=1.24): methyl butyrate (clogP=1.24): propyl acetate (clogP=1.24): 4-methylpentan-2-one (clogP=1.25): 2-acetyl-5-methyl furan (clogP=1.26): 3-methylbutanoic acid (clogP=1.26): tetrahydro furfuryl propionate (clogP=1.27): isovaleraldehyde (clogP=1.27): vanillin (clogP=1.28): 3-methyl-but-2-enoic acid (clgP=1.28): methyl furoate (clogP=1.29): octalactone gamma (clogP=1.3); butyl formate (clogP=1.32): furfurylidene acetone (clogP=1.32): guaiacol (clogP=1.32): phenyl ethyl alcohol (clogP=1.33): octalactone delta (clogP=1.33): 2-methylthiofuroate (clogP=1.35): pentanol (clogP=1.35): 2-acetyl-thiophene (clogP=1.36): 2-methylbutyraldehyde (clogP=1.36): 2-methyl-2-pentenal (clogP=1.36): pentanal (clogP=1.36): vanillic acids (clogP=1.36): butyl lactate (clogP=1.39): ethyl 2-ethylacetoacetate (clogP=1.39): pentanoic acid (clogP=1.39): hexenol-3-cis (clogP=1.4): hexenol-4-cis (clogP=1.4): (E)-4-hexenal (clogP=1.41): methylbenzyl alcohol (clogP=1.41): phenyl acetic acid pure (clogP=1.41): anisyl formate (clogP=1.42); ethyl-3-hydroxyhexanoate (clogP=1.42):2-methylpent-3-enoic acid (clogP=1.42): veratrum aldehyde (3.4-dimethoxy benzaldehyde) (clogP=1.44): 4-methyl-2-pentenal ((clogP=1.44): dimethyl-4-methoxy-3(2h)-furanone (clogP=1.47): diethyl succinate (clogP=1.48): acetoxy-2.5-dimethyl-3(2h)furanone (clogP=1.48): benzaldehyde (clogP=1.5): phenyl propionic acid (clogP=1.5); and benzyl formate (clogP=1.5).

Suitable ingredient Fᵢⱼ having a clogP(Fᵢⱼ) value from 1.51 to 2.5 may include hydroxy citronellal (clogP=1.54): ethyl isobutyrate (clogP=1.55): methyl 2-methyl butyrate (clogP=1.55): 6-methyl-3.5-heptadien-2-one (clogP=1.55): (E)-2-hexenal (clogP=1.58): acetophenone (clogP=1.58): tetramethyl pyrazine (clogP=1.58): furfuryl mercaptan (clogP=1.59): (E)-2-hexenol (clogP=1.6): homofuronol (clogP=1.6): cinnamic alcohol (clogP=1.61): salicylic aldehyde (clogP=1.61): (e,e)-3.5-octadien-2-one (clogP=1.62): dihydrocoumarin (clogP=1.63): isobutyl acetate (clogP=1.64): (Z)-3-hexenoic acid (clogP=1.64): t(E)-3-hexenoic acid (clogP=1.64): furfuryl propionate (clogP=1.66): ethyl dimethyl pyrazine (clogP=1.66): 3-ethyl-2.(5 or 6)-dimethyl-pyrazine (clogP=1.66): 2-ethyl-3-methoxy-pyrazine (clogP=1.67): 2.4-heptadienal (clogP=1.68): 2-ethylbutanoic acid (clogP=1.70): 2-methylpentanoic acid (clogP=1.70): phenyl propyl alcohol (clogP=1.71): isoamyl formate (clogP=1.72): heliotropin (clogP=1.76): butyl acetate (clogP=1.77): ethyl butyrate (clogP=1.77); methyl valerate (clogP=1.77): anisyl aldehyde (clogP=1.78): cinnamic acid (clogP=1.78): furfuryl thioacetate (clogP=1.78): cinnamic acid (clogP=1.78): 4-methylpentanoic acid (clogP=1.79): phenyl acetaldehyde (clogP=1.78): 4-methylpentanoic acid (clogP=1.79): 2-methyl-4.5-dihydrofuran-3-thiol acetate (clogP=1.79): mint lactone (3.6-dimethyl-5.6.7.7a-tetrahydro-4H-1-benzofuran-2-one) (clogP=1.8): acetanisol (clogP=1.8): methoxy phenyl butanone (clogP=1.81): ethyl vanillin (clogP=1.81): linalool oxide (clogP=1.81): whiskey lactone (clogP=1.82): methyl heptenone (clogP=1.82): methyl phenyl acetate (clogP=1.82): methyl-6-hepten-5-one-2 (clogP=1.82): creosol (clogP=1.82): 2-(4-methylphenyl)ethanol (clogP=1.83): nonalactone gamma (clogP=1.83): amyl formate (clogP=1.85): ethyl crotonate (clogP=1.86): hydroxynonanoic acid. delta-lactone (clogP=1.86): nonalactone delta (clogP=1.86): phenyl-3-propanal (clogP=1.87): hexanol (clogP=1.88): anisyl acetate (clogP=1.88): 3-methyl-2-buten-1-yl acetate (clogP=1.88): hexan-1-ol (clogP=1.88): filbertone ((E)-5-methylhept-2-en-4-one) (clogP=1.88): benzoic acid (clogP=1.89): 2-ethylbutyraldehyde (clogP=1.89); hexanal (clogP=1.89): (Z)-3-hexenyl formate (clogP=1.9): heptanone-2 (clogP=1.91): jasmolactone ((E)-6-(pent-3-en-1-yl)tetrahydro-2H-pyran-2-one) (clogP=1.91): n-furfurylpyrrole (clogP=1.91): 3-heptanone (clogP=1.91): 1-hepten-3-ol (clogP=1.91): cresol ortho (clogP=1.92): hexanoic acid (clogP=1.92): piperonyl acetate (clogP=1.92): 1-butenyl-methyl sulfide (clogP=1.93): (E)-2-hexenoic (clogP=1.94): (Z)-4-heptenal (clogP=1.94): (z)-1.5-octadien-3-ol (clogP=1.95): benzyl acetate (clogP=1.96): (Z)-3-hexenyl lactate (clogP=1.96): trithia-2.3.5-hexane (clogP=1.96); cresol meta (clogP=1.97): diethyl-(2.5 +2.6) 3-methylpyrazine (clogP=1.97): 2-methoxycinnamic aldehyde (clogP=1.97): cresol para (clogP=1.97): para tolyl aldehyde (clogP=1.99): 4-methylphenyl acetate (clogP=1.99): 2-ethyl 4-methyl thiazole (clogP=2.01); methyl (Z)-3-hexenoate (clogP=2.01): prenyl ethyl ether (clogP=2.04): dimethyl benzyl carbinol (clogP=2.04): cinnamic aldehyde (clogP=2.05): methylphenethyl ether (clogP=2.05); methoxy-4-vinylphenol (clogP=2.05): furfuryl methyl sulfide (clogP=2.07); carvone laevo (clogP=2.08): ethyl 2-methylbutyrate (clogP=2.08): methyl acetophenone (clogP=2.08): benzothiazole (clogP=2.08): 2-methyl-1-propanethiol (clogP=2.1): oct-2-en-4-one (clogP=2.1): octen-3-one (clogP=2.1): oct-2-en-4-one (clogP=2.1): (E)-2-heptenal (clogP=2.11); methyl benzoate (clogP=2.11): methyl anthranilate (clogP=2.12): indole pure (clogP=2.13): benzylidene acetone (clogP=2.14): 1.3-dimethoxy benzene (clogP=2.15): dimethyl hydroquinone (clogP=2.15): ethyl tiglate (clogP=2.16): ethyl isovalerate (clogP=2.17): 5-ethyl-2-methylpyridine (clogP=2.17): isoamyl acetate (clogP=2.17): isobutyl propionate (clogP=2.17): methyl thiobenzoate (clogP=2.17): 2-methylbutyl acetate (clogP=2.17): 3-methyl-2.4-nonadione (clogP=2.18): fenchone (clogP=2.18): 3-methyl-2.4-nonadione (clogP=2.18): 2-heptanol (clogP=2.19): 4-vinylphenol (clogP=2.20); carvone (clogP=2.20): cyclohexyl acetate (clogP=2.21): 2.4-octadien-1-al (clogP=2.21): phenyl-2-butenal (clogP=2.21); butanethiol (clogP=2.23): styrallyl acetate (clogP=2.27): phenyl ethyl acetate (clogP=2.28): isophorone (clogP=2.28): methyl anisate (clogP=2.28): 2-heptanol (clogP=2.29): 3-methyl hexanal (clogP=2.29); ethyl valerate (clogP=2.3): methyl hexanoate (clogP=2.3): amyl acetate (clogP=2.3): propyl butyrate (clogP=2.3): eugenyl acetate (clogP=2.3): dihydro actinidiolide (clogP=2.32): methyl salicylate (clogP=2.33): campholenic aldehyde (clogP=2.34): (Z)-3-hexenyl-acetate (clogP=2.34): ethyl phenyl acetate (clogP=2.35): ethyl guaiacol para (clogP=2.35); decalactone gamma (clogP=2.36): 1-hexyl formate (clogP=2.38): 2-methyl-3 methylthiofuran (clogP=2.38): decalactone delta (clogP=2.39): 3-methyl-2-butanethiol (clogP=2.41): benzyl mercaptan (clogP=2.41): heptanol (clogP=2.41): 2-isopropyl-4-methylthiazole (clogP=2.41): 2.5-dimethyl phenol (clogP=2.42): 3.4-dimethylphenol (clogP=2.42): heptanal(clogP=2.42); methyl jasmonate (methyl 2-(3-oxo-2-pent-2-enylcyclopentyl)acetate) (clogP=2.43): ethyl phenyl glycidate (clogP=2.43): octen-1-ol-3 (clogP=2.43): octanone-2 (clogP=2.44): methyl hexyl ketone (clogP=2.44): 2-isobutyl thiazole (clogP=2.44): 3-octenol (clogP=2.44): heptanoic acid (clogP=2.45): para methyl benzyl acetate (clogP=2.46): methyl cinnamate (clogP=2.47): isobutyl isobutyrate (clogP=2.48): benzyl propionate (clogP=2.49): piperitone laevo (clogP=2.49): para ethyl phenol (clogP=2.5): and 3.6-nonadien-1-ol (clogP=2.5).

Suitable ingredient Fᵢⱼ having a clogP(Fᵢⱼ)value from 2.51 to 3.5 may include ethyl 3-hexenoate (clogP=2.54): (E)-2-hexenyl acetate (clogP=2.54): verbenone (clogP=2.55); cinnamyl acetate (clogP=2.55): cresyl methyl ether para (clogP=2.57); isoeugenol (clogP=2.58): 1-(4-methoxyphenyl)-1-penten-3-one (clogP=2.59): furfuryl isovalerate (clogP=2.59): isobutyl methoxy pyrazine (clogP=2.59): ethyl 2-methylpentanoate (clogP=2.61): carveol laevo (clogP=2.62): 3-nonen-2-one (clogP=2.63): terpineol alpha (clogP=2.63): 6-pentyl-2h-pyran-2-one (clogP=2.64): (E)-2-octenal (clogP=2.64): ethyl benzoate (clogP=2.64): jasmone-cis (clogP=2.64): ethyl anthranilate (clogP=2.65): (E)-2-octen-1-ol (clogP=2.65): phenyl propyl acetate (clogP=2.66): dimethyl anthranilate (clogP-2.66): isobutyl 3-methylthio butyrate (clogP=2.68): 2.6-nonadienal(clogP=2.68): 2.6-nonadienol (clogP=2.7): isobutyl butyrate (clogP=2.7): 2-isopropyl phenol (clogP=2.7): oct-3-enoic acid (clogP=2.7): methyl heptine carbonate (clogP=2.72): 2-octanol (clogP=2.72): 3-octanol (clogP=2.72): (E.E)-2.4-nonadienal (clogP=2.74): terpinen-4-ol (clogP=2.74): isoamyl propionate (clogP=2.74): iso-pulegol (clogP=2.75): linalool (clogP=2.75): 2-acetylnaphthone (clogP=2.76): isoamyl propionate (clogP=2.76): isobutyl 2-butenoate (clogP=2.78): methyl propyl disulfide (clogP=2.8): 1.4-cineole (clogP=2.81): para-ethyl anisate (clogP=2.81): 2-ethylhexanol (clogP=2.81): 6-methyl heptanal (clogP=2.82): butyl butyrate (clogP=2.82): eucalyptol (clogP=2.83): ethyl hexanoate (clogP=2.83): hexyl acetate (clogP=2.83): methyl heptanoate (clogP=2.83): menthone (clogP=2.83): frescomenthe (clogP=2.84): 6-methylheptanoic acid (clogP=2.85): ethyl salicylate (clogP=2.86): melonal (clogP=2.87): (Z)-3-hexenylpropionate (clogP=2.87): cuminic aldehyde (clogP=2.88): peach pure (5-heptyldihydrofuran-2(3H)-one) (clogP=2.89): butyl phthalide (clogP=2.9): 2-methyl-3-(para-methyl-phenyl)-propanal (clogP=2.9): ethyl (E)-2-hexenoate (clogP=2.91): undecalactone delta (clogP=2.92): safranal (clogP=2.93): octan-1-ol (clogP=2.94); citral (clogP=2.95): octanal (clogP=2.95): ethyl methyl phenyl glycidate (clogP=2.95): nonanone-2 (clogP=2.96): nerolex (clogP=2.97): geraniol (clogP=2.97): nerol (clogP=2.97); octanoic acid (clogP=2.98): (Z)-6-nonenol (clogP=2.98): dimethyl benzyl carbinyl acetate (clogP=2.99): ethyl cinnamate (clogP=2.99): (Z)-6-nonenal (clogP=2.99): isoamyl isobutyrate (clogP=3.01): 3-propylidene phthalide (clogP=3.01): benzyl butyrate (clogP=3.02); butyl butyro lactate (clogP=3.02): methyl eugenol-iso (clogP=3.05): allyl caproate (clogP=3.07): (Z)-4-decenal (clogP=3.09): 4-methyloctanoic acid (clogP=3.09): 3.5.5-trimethylhexanal (clogP=3.09): fenchyl alcohol (clogP=3.1): borneol (clogP=3.1): isobutyl isovalerate (clogP=3.1); iso borneol (clogP=3.1): isobutyl isovalerate (clogP=3.1): methyl dihydro jasmonate (clogP=3.1); vanitrope ((E)-2-ethoxy-5-(prop-1-en-1-yl)phenol) (clogP=3.11): phenyl ethyl isobutyrate (clogP=3.12); decen-2-one: 3-(clogP=3.16): (E)-2-nonenal (clogP=3.16): rose oxide (clogP=3.17): thymol (clogP=3.2): thymol crystals (clogP=3.2): 2-isopropyl-5-methylhexen-2-al (clogP=3.21); butyl isovalerate (clogP=3.23): methyl propyl trisulfide (clogP=3.23): 2-methylbutyl butyrate (clogP=3.23): isoamyl butyrate (clogP=3.23): menthol (clogP=3.23): methyl octyne carbonate (clogP=3.25): citronellol (clogP=3.25): citroxide (clogP=3.26): citronellal (clogP=3.26): 2.4-decadienal (clogP=3.27): isobutyl phenyl acetate (clogP=3.28): diallyl disulfide (clogP=3.29); dibenzyl ether (clogP=3.3): isopropyl cinnamate (clogP=3.3): piperine (clogP=3.31): anethol synthetic (clogP=3.31): phenyl ethyl butyrate (clogP=3.34): carvacrol (clogP=3.35): pentyl butyrate (clogP=3.36): hexyl propionate (clogP=3.36): ethyl heptanoate (clogP=3.36): heptyl acetate (clogP=3.36): methyl octanoate (clogP=3.36): propyl hexanoate (clogP=3.36): octenyl acetate (clogP=3.38): octenyl-3 acetate (clogP=3.38): lime oxide (clogP=3.39): (Z)-3-hexenyl butyrate (clogP=3.4): carvyl acetate (clogP=3.41): benzyl isovalerate (clogP=3.42); dodecalactone gamma (clogP=3.42): isoamyl isobutyrate (clogP=3.42): dodecalactone delta (clogP=3.45): nonanol (clogP=3.47): geranyl formate (clogP=3.47): nonanal (clogP=3.48); and 2-decanone (clogP=3.49).

Suitable ingredient Fᵢⱼ having a clogP(Fᵢⱼ)value from 3.51 to 4.5 may include nonanoic acid (clogP=3.51): isoamyl 2-methyl butyrate (clogP=3.53): butylidene phtalide (clogP=3.54); terpinyl acetate (clogP=3.58): benzyl phenyl acetate (clogP-3.59): 5-ethyl-4-methyl-2-(1-methylpropyl)-thiazoline (clogP=3.6): ethyl octenoate-3 (clogP=3.6): 2- heptanethiol (clogP=3.6): (E)-2-hexenyl butyrate (clogP=3.6): methyl 3-nonenoate (clogP=3.6): isopentyl isovalerate (clogP=3.63): 2-methylbutyl 3-methylbutanoate (clogP=3.63): nonadienyl acetate (clogP=3.65):

methyl para-tert-butylphenylacetate (clogP=3.65): 3-octyl acetate (clogP-3.66): 5-methyl-2-phenyl-2-hexenal (clogP=3.66) :: (E)-2-decenal (clogP=3.69): dihydrocarvyl acetate (clogP=3.69): isopulegyl acetate (clogP=3.69): linalyl acetate (clogP=3.7): ionone alpha (clogP=3.71): (Z)-3-hexenyl 2-methylbutyrate (clogP=3.71: phenyl ethyl tiglate (clogP=3.73): phenyl ethyl isovalerate (clogP=3.74): pelargol (clogP=3.74): isobutyl hexanoate (clogP=3.75):

3-methyl-butyl valerate (clogP=3.75): citronellyl formate (clogP=3.75); naphthyl ethyl ether beta (clogP=3.76): ionone beta pure (clogP=3.77); bis(2-methyl-3-furyl) disulfide (clogP=3.79); menthen-9-yl acetate (clogP=3.79): (Z)-3-hexenyl isovalerate (clogP=3.8): menthyl lactate (clogP=3.8): 2.4-undecadienal (clogP=3.8): isoamyl phenylacetate (clogP=3.81): damascone alpha (clogP=3.82): cyclamen aldehyde (3-(4-isopropylphenyl)-2-methylpropanal) (clogP=3.83):

para-cresyl phenyl acetate (clogP=3.84): octyl acetate(clogP=3.88); butyl hexanoate (clogP=3.88): octyl acetate (clogP=3.88): ethyl octanoate (clogP=3.88): hexyl butyrate (clogP=3.88): 4-ethyloctanoic acid (clogP=3.91): 4-methylnonanoic acid (clogP=3.91): neryl acetate (clogP=3.92): phenyl ethyl phenyl acetate (clogP=3.92): geranyl acetate (clogP=3.92): 2-pentylfuran (clogP=3.93): pentyl phenyl acetate (clogP=3.94): benzyl benzoate (clogP=3.94):

ethyl 3-octenoate(clogP=3.97): methyl 2-nonenoate(clogP=3.97): decanol (clogP=4): decanal (clogP=4.01): cinnamyl isovalerate (clogP=4.01): methyl nonyl ketone (clogP=4.02): 2-undecanone (clogP=4.02): dimethyl benzyl carbinyl butyrate (clogP=4.04): isobornyl acetate (clogP=4.04): dihydroionone beta (clogP=4.04): bornyl acetate (clogP=4.05): 9-decenoic acid (clogP=4.05): cymene para (clogP=4.07): methyl alpha-ionone (clogP=4.07): allyl cyclohexyl propionate (clogP=4.14): nootkatone (clogP=4.15); benzyl salicylate (clogP=4.16): menthyl acetate pure (clogP=4.17): (Z)-3-hexenyl (Z)-3-hexenoate (clogP=4.18): hexyl 2-methylbutyrate (clogP=4.19): citronellyl acetate (clogP=4.2): phenyl acetaldehyde di isobutyl acetal (clogP=4.21): 2-undecenal (clogP=4.22): irone alpha (clogP=4.23): benzyl cinnamate (clogP=4.23): diphenyl oxide (clogP=4.24): damascenone (clogP=4.27): (Z)-3-hexenyl benzoate (clogP=4.27): isoamyl hexanoate (clogP=4.28): dihydronootkatone (clogP=4.3): ocimene (clogP=4.33): delta-3 carene (clogP=4.33): myrcene (clogP=4.33) limonene (clogP=4.35): terpinene gamma (clogP=4.35): terpinolene (clogP=4.35): thiogeraniol (clogP=4.38): phellandrene (clogP=4.41): ethyl nonanoate (clogP=4.41): nonyl acetate (clogP=4.41): amyl hexanoate (clogP=4.41): terpinene alpha (clogP=4.41); ethyl pelargonate (clogP=4.41): neryl propionate (clogP=4.44): geranyl propionate (clogP=4.44): isoamyl cinnamate (clogP=4.45): isoamyl salicylate (clogP=4.45): ethyl-4-decenoate (clogP=4.46): (Z)-3-hexenyl hexanoate (clogP=4.46): and amyl cinnamic aldehyde (clogP=4.47).

Suitable ingredient Fᵢⱼ having a clogP(Fᵢⱼ)value higher than 4.50 may include delta-tetradecalactone (clogP=4.51): cedrol (clogP=4.53): linalyl isobutyrate (clogP-4.53): undecanal (clogP=4.54): phenyl ethyl cinnamate (clogP=4.56): ethyl decadienoate (clogP=4.61): ethyl 2,4-decadienoate ((2E,4Z)-ethyl deca-2,4-dienoate) (clogP=4.61): terpinyl butyrate (clogP=4.63); octen-1-yl butanoate (clogP=4.66): dodecanoic acid (clogP=4.67): damascone beta (clogP=4.69): pinene alpha (clogP=4.7): camphene (clogP=4.7): pinene beta (clogP=4.7): octyl iso butyrate (clogP=4.72): citronellyl propionate (clogP=4.73): caryophyllene oxide (clogP=4.74): linalyl butyrate (clogP=4.75): dodecenal (clogP=4.75): nerolidol (clogP=4.78): cinnamyl cinnamate (clogP=4.84): 2-hexyl thiophene (clogP=4.93): decyl acetate (clogP=4.94): ethyl decylate (clogP=4.96): ethyl decanoate (clogP=4.96): hexyl hexanoate (clogP=4.96): geranyl butyrate (clogP=4.97): farnesol (clogP=5): ethyl-(E)-2-decenoate (clogP=5.03): citronellyl butyrate-iso (clogP=5.04): dodecan-1-ol (clogP=5.05): dodecanalc (clogP=5.07): undecatriene (clogP=5.15); linalyl isovalerate (clogP=4.535.15): geranyl isovalerate (clogP=5.17): citronellyl butyrate (clogP=5.25): (E)-2-tridecenal (clogP=5.28): isoamyl octanoate (clogP=5.34): thibetolide (clogP=5.35): ambrettolide (clogP=5.42): ambrofix (clogP=5.47): linalyl benzoate (clogP=5.62): dodecyl acetate (clogP=6): butyl undecylenate (clogP=6.05): valencene (clogP=6.3); farnesene (clogP=6.36): bisabolene (clogP=6.38): and caryophyllene (clogP=6.45).

In addition to the clogP selection criteria discussed hereinabove, it may be advantageous to also consider the vapor pressure of the off-odor counteracting flavor ingredient Fᵢⱼ as an additional selection criteria. The vapor pressure determines the rate of evaporation of flavor ingredients and their remanence in the gas phase where the off-odor is perceived. An off-odor counteracting flavor ingredient may be effective as long as it remains in the gas phase. It is therefore advantageous if the vapor pressure of the flavor ingredient is in a comparable order of magnitude to that of the off-odor component this flavor ingredient is aimed to counteract. If the vapor pressure of the off-odor counteracting flavor ingredient is too high, then its life time in the gas phase may be too short to insure off-odor counteraction over time.

In particular embodiments, the vapor pressure of the off-odor counteracting flavor ingredient Fᵢⱼ is less than 10 times the vapor pressure of the off-odor component Oᵢ, more particularly equal to or less than the vapor pressure of the off-odor component Oᵢ.

However, in particular embodiments, it may be sufficient that the vapor pressure of the off-odor counteracting flavor ingredient is higher than the vapor pressure of the off-note component. This is in particular the case if an instantaneous off-note mitigation is desired, for example on opening a packaging containing the food or beverage product, on pooring this food or beverage product, or during the use of this food or beverage product.

The vapor pressure of a flavor ingredient may be measured by any technique known to the art or calculated. A particularly suitable calculation method is provided by the vapor pressure module implemented in the ACD labs software suite, available from Advanced Chemistry Development, Inc., Toronto. Table 1 shows an illustrative list of flavor ingredients Fᵢⱼ vapor pressures at 25° C., calculated using this method.

TABLE 1

| | Vapor pressure | | Vapor pressure |
|---|---|---|---|
| Flavor ingredient Fij | ACD [Torr] | Flavor ingredient Fij | ACD [Torr] |
| phenyl ethyl cinnamate | 0.000000849 | (Z)-3-hexenyl 2- | 0.0613 |
| | | methylbutyrate | |
| phenyl ethyl cinnamate | 0.0000008 | methyl salicylate | 0.07 |
| ambrettolide | 0.0000014 | (&)-6-nonenol | 0.08 |
| benzyl cinnamate | 0.00001 | creosol | 0.08 |
| phenyl ethyl phenyl acetate | 0.00002 | heptalactone gamma | 0.08 |
| cresyl phenyl acetate para | 0.00002 | dimethyl benzyl carbinol | 0.09 |
| thibetolide | 0.0001 | ethyl phenyl acetate | 0.09 |
| menthyl lactate | 0.0001 | linalool | 0.09 |
| benzyl phenyl acetate | 0.0001 | isobornyl acetate | 0.10 |
| triethyl citrate | 0.0002 | bornyl acetate pure laevo | 0.10 |
| benzyl salicylate | 0.0002 | undecanone-2 | 0.10 |
| ethyl maltol | 0.0002 | Iso-pulegol | 0.10 |
| benzyl benzoate | 0.0003 | angelica lactone alpha | 0.1 |
| vanitrope | 0.0003 | benzyl propionate | 0.1 |
| maltol | 0.0003 | octan-1-ol | 0.1 |
| nootkatone | 0.0004 | linalyl acetate | 0.1 |
| cedrol | 0.0006 | ethyl pelargonate | 0.1 |
| 5-methyl-2-phenyl-2- | 0.0006 | methyl heptine carbonate | 0.1 |
| hexenal | | | |
| ethyl vanillin | 0.0009 | methyl phenyl acetate | 0.1 |
| 2-acetylnaphthone | 0.0010 | valerolactone delta | 0.1 |
| methyl epi jasmonate | 0.001 | phenyl-3-propanal | 0.1 |
| raspberry ketone | 0.001 | safranal | 0.1 |
| carvyl acetate | 0.001 | hexenyl-3-cis butyrate | 0.1 |
| dodecalactone gamma | 0.002 | methyl nonenoate-2 | 0.1 |
| ethyl phenyl glycidate | 0.002 | hexalactone gamma | 0.2 |
| undecalactone delta | 0.002 | 2,6,6-trimethylcyclohex- | 0.2 |
| | | 2-ene-1,4-dione | |
| vanillin | 0.002 | benzyl alcohol | 0.2 |
| (Z)-3-hexenyl benzoate | 0.002 | hexanoic acid | 0.2 |
| dodecanol | 0.002 | frescomenthe | 0.2 |
| citronellyl isobutyrate | 0.002 | 4-vinylphenol | 0.2 |
| raldeine | 0.003 | acetyl-2 pyrazine | 0.2 |
| sulfurol | 0.003 | acetyl-2 thiazole | 0.2 |
| (E)-2-tridecenal | 0.004 | guaiacol | 0.2 |
| jasmolactone | 0.004 | ethyl benzoate | 0.2 |
| veratrum aldehyde | 0.004 | methyl acetophenone | 0.2 |
| methoxy phenyl butanone | 0.004 | acetate c 8 octylic | 0.2 |
| irone alpha | 0.004 | styrallyl acetate | 0.2 |
| dibenzyl ether | 0.004 | aldehyde c 10 decylic | 0.2 |
| phenyl acetic acid pure | 0.005 | decanal | 0.2 |
| 3,4-dimethylcyclopentane- | 0.005 | ethyl acetoacetate | 0.2 |
| 1,2-dione | | | |
| citronellyl propionate | 0.005 | cresol para | 0.2 |
| corylone dried | 0.005 | citronellal | 0.2 |
| damascenone total | 0.005 | ethyl octanoate | 0.2 |
| naphthyl ethyl ether beta | 0.005 | hexyl butyrate | 0.2 |
| ethyl methyl phenyl | 0.006 | valerolactone gamma | 0.2 |
| glycidate | | | |
| damascone beta | 0.007 | dimethyl hydroquinone | 0.3 |
| phenyl ethyl butyrate | 0.007 | menthone | 0.3 |
| ethyl cinnamate | 0.007 | benzyl formate | 0.3 |
| eugenyl acetate | 0.008 | nonadienal | 0.3 |
| decalactone delta | 0.008 | nonadienol-2,6 | 0.3 |
| damascone alpha | 0.008 | acetophenone | 0.3 |
| decalactone gamma | 0.009 | methyl benzoate | 0.3 |
| nonalactone gamma | 0.009 | diethyl malonate | 0.3 |
| cyclamen aldehyde extra | 0.009 | ethyl 3-hydroxy butyrate | 0.4 |
| allyl cyclohexyl propionate | 0.009 | (Z)-3-hexenylpropionate | 0.4 |
| ambrofix | 0.009 | 5-methyl-furfural | 0.4 |
| cinnamyl acetate | 0.009 | isoamyl isobutyrate | 0.5 |
| ethyl decadienoate | 0.010 | acetyl-2 pyridine | 0.5 |
| jasmone-cis | 0.010 | octen-1-ol-3 | 0.5 |
| phenyl ethyl isobutyrate | 0.010 | nonanal | 0.5 |
| dihydroionone beta | 0.01 | rose oxide co | 0.6 |
| dodecenal | 0.01 | methyl-2 butyric acid | 0.6 |
| heliotropin | 0.01 | hexyl propionate | 0.6 |
| phenyl propyl acetate | 0.01 | ethyl heptanoate | 0.6 |
| methyl eugenol-iso | 0.01 | pentyl butyrate | 0.6 |
| methyl cinnamate | 0.01 | melonal | 0.6 |
| valencene 80% | 0.01 | allyl caproate | 0.7 |
| cinnamic alcohol | 0.01 | ethyl-3 dimethyl-2,(5 or | 0.8 |
| | | 6) pyrazine | |
| linalyl butyrate-iso | 0.01 | (E)-2-hexenol | 0.9 |
| benzoic acid(e210) | 0.01 | hexanol | 0.9 |
| (Z)-3-hexenyl (Z)-3- | 0.01 | (Z)-3-hexenol | 1.0 |
| hexenoate | | | |
| caryophyllene | 0.01 | terpinolene | 1.1 |
| nerolex | 0.01 | isopropyl-2 methyl-4 | 1.2 |
| | | thiazole | |
| geraniol | 0.01 | (Z)-3-hexenyl acetate | 1.2 |
| citronellyl acetate | 0.01 | filbertone | 1.2 |
| dimethyl benzyl carbinyl | 0.01 | methyl-6-hepten-5-one-2 | 1.3 |
| acetate | | | |
| ionone alpha | 0.01 | hexyl acetate | 1.4 |
| ionone alpha | 0.01 | ocimene | 1.6 |
| decanol | 0.01 | isobutyric acid | 1.6 |
| geranyl formate | 0.02 | eucalyptol cosmos | 1.6 |
| acetanisol | 0.02 | cresyl methyl ether para | 1.7 |
| methyl anthranilate | 0.02 | cymene para | 1.7 |
| ionone beta pure | 0.02 | ethyl hexanoate | 1.7 |
| nonalactone delta | 0.02 | trimethyl pyrazine | 1.7 |
| citronellol extra | 0.02 | octanone-2 | 1.7 |
| dimethyl anthranilate | 0.02 | butyl butyrate | 1.9 |
| linalool oxide | 0.02 | acetoin | 1.9 |
| diphenyl oxide | 0.02 | isoamyl alcohol | 2.0 |
| neryl acetate | 0.03 | octanal | 2.1 |
| geranyl acetate | 0.03 | myrcene 90 | 2.3 |
| isobutyl phenyl acetate | 0.03 | isoamyl propionate | 2.4 |
| phenyl propyl alcohol | 0.03 | pinene beta | 2.4 |
| hexyl hexanoate | 0.03 | (Z)-3-hexenyl-formate | 2.6 |
| terpineol alpha | 0.03 | ethyl 2-methylpentanoate | 2.9 |
| benzyl isovalerate | 0.03 | ethyl pyruvate | 3.1 |
| carvacrol | 0.03 | methoxy methyl pyrazine | 3.3 |
| indole pure | 0.03 | camphene | 3.4 |
| citronellyl formate | 0.03 | aldehyde c 7 heptylic | 3.9 |
| menthol | 0.03 | methyl hexanoate | 4.0 |
| ethyl decanoate | 0.03 | dimethyl-2,5 pyrazine | 4.0 |
| ethyl salicylate | 0.03 | (E)-2-hexenal | 4.6 |
| benzyl butyrate | 0.04 | 2-heptanone | 4.7 |
| thymol crystals | 0.04 | isoamyl acetate | 5.6 |
| pelargol | 0.04 | ethyl 2-methylbutyrate | 7.9 |
| terpinyl acetate | 0.04 | ethyl isovalerate | 7.9 |
| octalactone delta | 0.04 | amyl formate | 8.9 |
| borneol | 0.04 | hexanal | 10.9 |
| nonanol | 0.04 | butyl acetate | 11.5 |
| aldehyde c 9 nonylic | 0.04 | 2,3-hexanedione | 12.4 |
| octalactone gamma | 0.04 | ethyl butyrate | 13.9 |
| 2-methyl-3-(para-methyl- | 0.04 | isoamyl formate | 15.3 |
| phenyl)-propanal | | | |
| terpinen-4-ol | 0.05 | methyl 2-methylbutyrate | 21.6 |
| cuminic aldehyde | 0.05 | ethyl isobutyrate | 21.6 |
| phenyl ethyl acetate | 0.06 | acetyl propionyl (2,3- | 26.4 |
| | | pentanedione) | |
| (Z)-3-hexenyl 2- | 0.06 | ethyl propionate | 44.5 |
| methylbutyrate | | | |
| carvone laevo | 0.07 | isovaleraldehyde | 49.3 |
| carvone dextro | 0.07 | ethyl acetate | 111.7 |
| anethol synthetic | 0.07 | isobutyraldehyde | 147.4 |
| fenchyl alcohol | 0.07 | | |

In addition to the clogP and vapor pressure, the off-odor counteracting flavor ingredient Fᵢⱼ may be selected based on their odor threshold or odor strength. The term odor detection threshold (ODT) used herein above refers to the average concentration above which a flavor ingredient can be perceived by a panelist and can be measured by olfactometry, as described, for example Mueller and Lamparsky in Perfumes: Art, Science and Technology, Chapter 6 “The Measurement of Odors” at pages 176-179 (Elsevier 1991). The odor detection threshold (ODT) may be measured by using an olfactometer according to procedures known to the art. The odor strength of a flavor ingredient may be assessed by measuring his concentration-intensity response curve.

More particularly, it may be particularly advantageous to consider the strength of the off-odor counteracting flavor ingredient at the level this ingredient is used in the food or beverage product.

In particular embodiments, the off-odor counteracting flavor ingredient Fᵢⱼ has an odor strength, at the level flavor ingredient is used in the food or beverage product, that is equal to or higher than the odor strength of the off-note component Oᵢ.

According to these particular embodiments, the effective amount of the flavor ingredient Fᵢⱼ may be defined as the amount at which the odor strength of this flavor ingredient is at least as high as the odor strength of the off-note component Oᵢ.

In addition to the clogP, vapor pressure, odor detection threshold or strength, the skilled in the art flavorist may advantageously select off-odor counteracting flavor ingredients Fᵢⱼ that have an olfactive profile compatible with the olfactive profile of the food or beverage product. The skilled in the art person will easily understand that, depending on the targeted product, ingredients having certain odors may be more suitable than others.

A suitable way to assess the odor characteristics of a product is to smell the product under controlled environmental conditions, such as temperature, relative humidity, and olfactive neutral environment.

Methods to define the olfactive profile of a flavor ingredient exist and can be used in the context of the present invention. For example, an odor may be defined by using pre-defined semantic attributes, such as “CITRUS”, as in the case of a lemon odor, a lime odor, an orange odor or a grapefruit odor and the like: “FRUITY”, as in the case of an apple odor, a peach odor, a berry odor, and the like: “GREEN”, as in the case of a freshly cut grass odor, a leaf odor, and the like: “AROMATIC/HERBAL”, as in the case of a resinous odor, a turpentine odor, a straw odor, and the like: “SPICY”, as in the case of a cinnamon odor, a clove odor, a pepper odor, and the like: “MILKY/CREAMY”, as in the case of a milk shake odor, a yogurt odor, and the like:

“FLORAL”, as in the case of a rose odor, a strawberry odor and the like: “WOODY”, as in the case of a sandal wood odor, a cedar odor, a patchouli odor, and the like: or “SWEET”, as in the case of a caramel odor, a vanilla odor, a cinnamon odor, and the like. Other semantic attributes may be defined if needed, depending on the desired accuracy of the odor definition. An odor may also be defined as a combination of semantic attributes. Numerous examples of alternative semantic attributes suitable for odor definitions may be found, for example, in S. Arctander, “Perfume and Flavor Chemicals”, Allured Pub. Corp. Wheaton, 1969 and on web sites, such as www.thegoodscentscompany.com.

More particularly, flavor ingredients having a pleasant odor may be preferred over pungent ones, such as thiols, pyrazines, thiazols and amines.

In particular embodiments, the flavor ingredients Fᵢⱼ are preferably selected from the group consisting of CHO compounds, in particular aldehydes, alcohols, esters, lactones, ketones, ethers ketals and O-heterocycles.

In particular embodiments, the flavor ingredients Fᵢⱼ are originating from nature, meaning they are not synthesized from petrochemical building blocks.

The at least one flavor ingredients Fᵢⱼ is typically admixed with other flavor ingredients.

In particular embodiments, the at least one flavor ingredient Fᵢⱼ may represent from 0.000001 wt.-% to 100 wt.-%, more particularly from 0.00001 wt.-% to 10 wt.-%, still more particularly from 0.00005 wt.-% to 2.5 wt.-% of the total weight of the odor active flavor ingredients present in the food or beverage product.

Alternatively, the at least one flavor ingredient Fᵢⱼ may be added directly to the food or beverage product, as such or diluted in a solvent

In particular embodiments, the at least one flavor ingredient Fᵢⱼ is added to the food or beverage product in the form of a 0.000001 wt.-% to 99.99999 wt.-%, more particularly a 10 wt.-% to 90 wt.-% solution in one ot more solvent solvent selected from the group consisting of water, glycerol, ethanol, 1-propanol. Isopropanol (2-propanol), propylene glycol (propane-1,2-diol), triethyl citrate (triethyl 2-hydroxypropane-1,2,3-tricarboxylate), tributyl citrate (2-hydroxy-1,2,3-propanetricarboxylic acid tributyl ester), triacetin (1,2,3-propanetriol triacetate), diacetin (1,2,3-propanetriol diacetate), medium chain triglycerides, and vegetable oils.

In a second aspect, the present disclosure provides a food or beverage product obtainable by the method disclosed hereinabove. Such food or beverage products may include savory products, dairy products, beverages, carbonated beverages, jelly drinks: alcoholic drinks: energy drinks: and nutraceutical formulations.

In particular embodiments, the food or beverage product comprises fish oil, more particularly oil docosahexaenoic acid (DHA), and a flavor composition comprising delta-nonalactone (clogP=2.39) and creosol (clogP=1.82). As shown in Example 2 hereinafter, these two flavor ingredients turned out to be effective off-odor counteractants against (Z)-4-heptenal (clogP=1.94), (Z)-1-octen-3-ol (clogP-2.44) and (E)-2-heptanal (clogP=1.58). This example illustrates the use of more than one off-odor counteracting ingredients to mitigate more than one off-odor components.

In a third aspect, the present disclosure provides a food or beverage product comprising a flavor composition comprising at least one flavor ingredient Fᵢⱼ having the features disclosed hereinabove. Such flavor compositions provides effective off-odor mitigation, when added to the food or beverage product. More particularly, such flavor compositions comprise from 0.000001 wt.-% to 100 wt.-%, more particularly from 0.00001 wt.-% to 10 wt.-%, still more particularly from 0.00005 wt.-% to 2.5 wt.-% of the at least one flavor ingredient Fᵢⱼ, based on the total weight of odor active flavor ingredients.

Flavor compositions according to the present disclosures may be admixed with various additives, such as solvents, antioxidants, chelating agents, preservatives, dyes, and the like. Furthermore, these flavor compositions may be encapsulated in microcapsules, according to methods known to the art.

Flavor compositions according to the present disclosure are suitable for use in all manner of flavored food and beverage products. Flavor compositions are particular suitable for use in food and beverage products comprising components having an intrinsic off-odor or being prone to off-odor formation during their life cycle. These especially include citrus beverages, such as lemon and orange juice, citrus flavored water, soft fruits flavored water, sport drinks, jelly drinks, neutral spirits, such as vodka and gin, flavored alcoholic drings, local energy drinks, ice cream, sorbet, frozen yogurt, milk, savory oils, savory extracts, dressings, soups, chewing gums, candies, gummy candies, chocolates, waffles, cookies, wafers, spreads, jams, margarine and nutraceutical formulations.

The flavor compositions may be used at any suitable level depending on the nature of the flavored product in which they are intended to be incorporated, and the intended use of the flavor product. Typical usage levels will include from about 0.001 to 1% by weight of the flavored product, more preferably from about 0.01 to 0.5% by weight of the flavored product, still more particularly from 0.05 to 0.4% by weight of the flavored product.

In a fourth aspect, the present disclosure provides the use of at least one selected flavor ingredient Fᵢⱼ to mitigate off-odors caused by one or more off-odor components Oi, the clogP value of the at least one selected flavor ingredient Fᵢⱼ, (clogP(Fᵢⱼ)), being close to that of the one or more off odor component Oᵢ, (clogP(Oᵢ)) by less than 0.75, more particularly less than 0.5 clogP unit.

In order to further illustrate the present invention and the advantages thereof, the following specific examples and comparative example areen, it being understood that same are intended only as illustrative and non-limiting.

### EXAMPLES

The following examples are given solely for the purpose of illustration and are not to be construed as limitations of the present invention, as many variations of the invention are possible without departing from the spirit and scope of the present disclosure.

### Example 1: Mitigation of selected off-notes

In Example 1.1 the off-note of a yogourt is acetic acid, this off-note is efficiently mitigated by using the odor active flavor ingredients listed in Table 1.1 at a level of from 0.000005 wt.-% to 0.0005 wt.-% based on the the total weight of the food or beverage product.

TABLE 1.1
Mitigation of acetic acid.

| | | | Vapor |
|---|---|---|---|
| | | | pressure |
| | | | (Torr at |
| | | ClogP | 25° C.) |
| | | (Daylight) | (ACD) |
| Off-odor | acetic acid | −0.19 | 13.9 |
| Off-odor | ethyl lactate | 0.33 | 1.2 |
| counteracting | valerolactone delta | −0.24 | 0.1 |
| flavor | valerolactone gamma | −0.28 | 0.2 |
| ingredients | acetoin | −0.20 | 1.9 |
| | acetyl propionyl | −0.84 | 26.4 |
| | maltol | 0.10 | 0.0003 |
| | ethyl pyruvate | 0.16 | 3.1 |
| | ethyl 3-hydroxy | 0.37 | 0.4 |
| | butyrate | | |

As apparent from Table 1, a number of off-odor counteracting flavor ingredients can be selected to counteract acetic acid in yogurts, depending on the desired organoleptic profile. For example ethyl lactate may be advantageously used in strawberry flavous, other berry flavours, pear flavours, tropical fruit flavours, yogurt flavours, cheese flavours, beer flavours, sake flavours. Furthermore, some of these ingredients have a vapor pressure that is much lower than acetic acid, meaning that these ingredients may provide a longlasting off-odor counteraction.

In Example 1.2, typical garlic off-notes of a energy drinks are 2-vinyl-4H-1,3-dithiine and Allicin. 2-vinyl-4H-1,3-dithiine off-note and Allicin are efficiently mitigated by adding a fruit flavor comprising the odor active flavor ingredients listed in Table 1.2 at levels of from 0.000001 wt.-% to 0.0001 wt.-%, besed on the total weight of the food or beverage product.

TABLE 1.2
Mitigation of 2-vinyl-4H-1,3-dithiine
and Allicin off-notes in energy drinks

| | | | Vapor |
|---|---|---|---|
| | | | pressure |
| | | | (Torr at |
| | | ClogP | 25° C.) |
| | | (Daylight) | (ACD) |
| Off-odor component | 2-vinyl-4H-1,3-dithiine | 2.33 | 0.1 |
| Off-odor | 4-vinylphenol | 2.20 | 0.2 |
| counteracting | isoamyl acetate | 2.17 | 5.3 |
| flavor | ethyl isovalerate | 2.17 | 7.9 |
| ingredients | methyl anthranilate | 2.12 | 0.02 |
| | methyl cinnamate | 2.47 | 0.01 |
| Off-odor component | Allicin | 1.9 | 0.04 |
| Off-odor | ethyl butyrate | 1.77 | 13.9 |
| counteracting | linalool oxide | 1.81 | 0.02 |
| flavor | Ethyl 2-methyl | 2.08 | 7.9 |
| ingredients | butyrate | | |
| | Isoamyl acetate | 2.17 | 5.6 |

As apparent from Table 1.2, a number of flavor ingredients can be selected to counteract 2-vinyl-4H-1,3-dithiine and Allicin in energy drinks using various fruity flavors, including citrus flavors, vanilla flavors, and berry flavors, depending on the desired organoleptic profile.

In Example 1.3, typical off-notes that may be present in citrus beverages are para-cresol and acetophenone. These off-notes are efficiently mitigated by adding a flavor comprising the odor active flavor ingredients listed in Table 1.3 at levels of from 0.00000005 wt.-% (0.0005 ppm) to 0.000005 wt.-% (0.5 ppm) (for ethyl vanillin: 0.0000001 wt.-% (0.01 ppm)), based on the total weight of the food or beverage product.

TABLE 1.3
Mitigation of para-cresol and acetophenone in beverages

| | | | Vapor |
|---|---|---|---|
| | | | pressure |
| | | | (Torr at |
| | | ClogP | 25° C.) |
| | | (Daylight) | (ACD) |
| Off-odor component | cresol para | 1.97 | 0.2 |
| Off-odor counteracting flavor | hexanal | 1.89 | 10.9 |
| ingredients | hexanoic acid | 1.92 | 0.2 |
| | hexan-1-ol | 1.88 | 0.9 |
| Off-odor component | acetophenone | 1.58 | 0.3 |
| Off-odor counteracting flavor | linalool oxide | 1.81 | 0.02 |
| ingredients | isoamyl formate | 1.72 | 15.3 |
| | ethyl butyrate | 1.77 | 13.9 |
| | ethyl vanillin | 1.81 | 0.01 |
| | butyl acetate | 1.77 | 11.5 |
| | (E)-2-hexenal | 1.58 | 4.6 |
| | (Z)-3-hexenol | 1.40 | 1 |

As apparent from Table 1.3, a number of off-odor counteracting flavor ingredients can be selected to counteract para-cresol and acetophenone in citrus beverages, citrus flavours, fruits flavours, and soda pop flavors, depending on the desired organoleptic profile. Furthermore, some of these ingredients have a vapor pressure that is much lower than that of the target off-odor, meaning that these ingredients may provide a longlasting off-odor counteraction. Conversely, ingredients such as hexanal, isoamyl formate, ethyl butyrate and butyl acetate may provide a fast, but non-lasting mitigation.

### Example 2 Mitigation of Fish Oil Off-Notes in a Vanilla Cream

This example is to illustrate the use of selected off-odor counteracting flavor ingredients to mitigate the off-odor derived from fish oil docosahexaenoic acid (DHA), alpha-linolenic acid (ALA,), and eicosapentaenoic acid (EPA) in a vanilla cream. The main components of the off-odor were identified as (E)-2-heptenal, (Z)-4-heptenal and 1-octen-3-ol. The prerequisite underlying the selection of the off-odor counteracting flavor ingredients was that these ingredients should be organoleptically compatible with both vanilla odor and taste.

The ClogP values of both off-odor components and potential off-odor counteracting flavor ingredients are reported in Table 2.

TABLE 2
Mitigation of fish oil off-odor in vanilla cream

| | | | Vapor |
|---|---|---|---|
| | | | pressure |
| | | | (Torr at |
| | | ClogP | 25° C.) |
| | | (Daylight) | (ACD) |
| Off-odor components | (Z)-4-heptenal | 1.94 | 0.2 |
| | (Z)-1-octen-3-ol | 2.44 | 0.1 |
| Off-odor counteracting flavor | delta-nonalactone | 2.39 | 0.018 |
| ingredient | | | |
| Off-odor component | (E)-2-heptenal | 1.58 | 1.8 |
| Off-odor counteracting flavor | creosol | 1.82 | 0.02 |
| ingredient | | | |

1. A method for mitigating off-odors in flavored food or beverage products, the method comprising the steps of:
a) identifying one or more off-odor components Oᵢ;
b) calculating the clogP of the one or more off-odor components Oᵢ, (clogP(Oᵢ));
c) for each of the one or more off-odor component Oᵢ identified in step a), adding to the flavored food or beverage product an effective amount of at least one flavor ingredient Fᵢⱼ having clogP(Fᵢⱼ)value(s) equal to clogP(Oᵢ)±0.75 clogP unit;
wherein, clogP(Oᵢ) and clogP(Fᵢⱼ)are the calculated octanol/water partition coefficient of both off-odor component Oᵢ and flavor component Fᵢ; and
wherein the effective amount of the at least one flavor ingredient Fᵢⱼ is from 0.000001 wt.-% to 100 wt.-%, based on the total weight of the odor active flavor components present in the flavored food or beverage product.

2. The method according to claim 1, wherein the at least one flavor ingredient Fᵢⱼ has a clogP(Fᵢⱼ) value from −1 to +0.5 and is selected from the group consisting of acetyl propionyl (2,3-pentanedione) (ClogP =−0.84); gamma butyrolactone (clogP =−0.8); diethyl tartrate (clogP =−0.69); formic acid (clogP =−054); 2,3-hexanedione (clogP =−0.31); 3,4-hexanedione (clogP =−0.31); valerolactone gamma (clogP =−0.28);
valerolactone delta (−0.24); acetaldehyde (clogP =−0.22); acetoin (clogP =−0.2);
tetrahydrofurfuryl alcohol (clogP =−0.12); 2-(hydroxyacetyl)furan (clogP-0.08); 2-acetylpyrazine (clogP =−0.08); maltol (clogP=0.1); sulfurol (clogP=0.13); ethyl pyruvate (clogP=0.16); methyl acetate (clogP=0.18); angelica lactone alpha (5-methyl-3H-furan-2-one) (clogP=0.2); 2,3-heptanedione (clogP=0.22); 2-methyltetrahydrofuran-3-one (clogP=0.24); ethyl formate (clogP=0.26); hexalactone delta (clogP-0.27); furfuryl alcohol (clogP=0.28); propanal (clogP=0.3); butan-2-one (clogP=0.32); propionic acid (clogP=0.33); ethyl lactate (clogP=0.33); ethyl acetoacetate (clogP=0.33); propionic acid (ClogP=0.34); ethyl 3-hydroxy butyrate (clogP=0.37); corylone dried (clogP=0.42); 2-acetyl-3-methylpyrazine (clogP=0.42); dimethyl succinate (clogP-0.42); 3-acetylpyridine (clogP=0.48); hexalactone gamma (clogP-0.48); and combinations thereof.

3. The method according to claim 1, wherein the at least one flavor ingredient Fᵢⱼ has a clogP(Fᵢⱼ)from 0.51 to 1.5 and is selected from the group consisting of 1-penten-3-one (clogP=0.52); pent-3-en-2-one (clogP=0.52); methyl-2-pyrrolyl ketone (clogP=0.59); butanol (clogP-0.6); 4-hydroxy-5-methyl-3(2h)-furanone (clogP=0.61); 3,4-dimethylcyclopentane-1,2-dione (clogP=0.62); 1,2-dimethyl-3,5-cyclopentadione (clogP=0.62); ethyl maltol (clogP-0.63); isobutyric acid (clogP=0.64); 3-hydroxybutanoic acid (clogp=0.64); dimethyl-2,3 pyrazine (clogP=0.66); ethyl levulinate (clogP=0.66); furfural (clogP=0.67); acetyl-2 thiazole (clogP=0.71); methyl propionate (clogP=0.71); ethyl acetate (clogP=0.71); methyl butenol (clogP=0.72); isobutyl alcohol (clogP=0.74); isobutyraldehyde (clogP=0.74); tetrahydrofurfuryl acetate (clogP=0.74); 2-acetylfuran (ClogP-0.76); methyl nicotinate (clogP=0.77); heptalactone gamma (clogP=0.77); butyraldehyde (clogP=0.83); pentan-2-one (clogP=0.85); butyric acid (clogP=0.86); ethyl-3-hydroxy-4-methyl-2(5h)-furanone (clogP=0.86); penten-1-ol, 3-cis (clogP=0.87); acetyl-2 pyridine (clogP=0.88); 4-pentenal (clogP=0.88); (E)-2-butenoic acid (clogP=0.89); methyl-3-hydroxyhexanoate (clogP=0.89); 4-pentenoic acid (clogP=0.91); 3-methyl-2-butenal (clogP=0.92); methyl-2 butene-2-ol-4 (prenol) (clogP=0.93); piperidine (clogP=0.93); prenol (clogP=0.94); 2-acetyl-3-ethylpyrazine (clogP=0.95); isoamyl alcohol (clogP=1); 4-hydroxy-3,5-dimethoxy-benzaldehyde (clogP=1.01); methyl isobutyrate (clogP=1.02); anisyl alcohol (clogP=1.02); dimethyl-2,5 pyrazine (clogP=1.03); 2,6,6-trimethylcyclohex-2-ene-1,4-dione (clogP=1.03); 4-hexen-3-one (clogP=1.04); 3-ethyl-2-hydroxy-2-cyclopenten-1-one (clogP=1.07); 1-phenyl-1,2-propanedione (clogP=1.07); zingerone (clogP=1.07); 2-acetyl-3,5-dimethylpyrazine (clogP=1.1); benzyl alcohol (clogP=1.1); 2,6-dimethoxyphenol (clogP=1.11); trimethyl pyrazine (clogP=1.11); 2-methylbutyric acid (clogP=1.13); diethyl malonate (clogP=1.13);
aldemax (1,2-bis(1-ethoxyethoxy)propane) (clogP=1.13); furonol (clogP=1.13);
pentanol-2 (clogP=1.13); methoxy methyl pyrazine (clogP=1.14); furfuryl acetate (clogP=1.14); 2.methylbutyric acid (ClogP=1.17); 5-methyl-furfural (clogP=1.17); 2-methyl-butan-1-ol (clogP=1.2); 2-ethyl 5,6 methyl pyrazine (clogP=1.22); ethyl-2 methyl-5 pyrazine (clogP=1.22); methyl-2 butanol (clogP=1.22); raspberry ketone (clogP=1.22);
4-methylpent-2-enoic acid (clogP=1.22); ethyl propionate (clogP=1.24); methyl butyrate (clogP=1.24); propyl acetate (clogP=1.24); 4-methylpentan-2-one (clogP=1.25); 2-acetyl-5-methyl furan (clogP=1.26); 3-methylbutanoic acid (clogP=1.26); tetrahydro furfuryl propionate (clogP=1.27); isovaleraldehyde (clogP=1.27); vanillin (clogP=1.28); 3-methyl-but-2-enoic acid (clogP=1.28); methyl furoate (clogP=1.29); octalactone gamma (clogP=1.3); butyl formate (clogP=1.32); furfurylidene acetone (clogP=1.32); guaiacol (clogP=1.32); phenyl ethyl alcohol (clogP=1.33); octalactone delta (clogP=1.33); 2-methylthiofuroate (clogP=1.35); pentanol (clogP=1.35); 2-acetyl-thiophene (clogP=1.36);
2-methylbutyraldehyde (clogP=1.36); 2-methyl-2-pentenal (clogP=1.36); pentanal (clogP=1.36); vanillic acids (clogP=1.36); butyl lactate (clogP=1.39); ethyl 2-ethylacetoacetate (clogP=1.39); pentanoic acid (clogP=1.39); hexenol-3-cis (clogP=1.4);
hexenol-4-cis (clogP=1.4); (E)-4-hexenal (clogP=1.41); methylbenzyl alcohol (clogP=1.41); phenyl acetic acid pure (clogP=1.41); anisyl formate (clogP=1.42); ethyl-3-hydroxyhexanoate (clogP=1.42); 2-methylpent-3-enoic acid (clogP=1.42); veratrum aldehyde (3,4-dimethoxybenzaldehyde) (clogP=1.44); 4-methyl-2-pentenal (clogP=1.44); dimethyl-4-methoxy-3(2h)-furanone (clogP=1.47); diethyl succinate (clogP=1.48); acetoxy-2,5-dimethyl-3(2h)furanone (clogP=1.48); benzaldehyde (clogP=1.5); phenyl propionic acid (clogP=1.5); benzyl formate (clogP=1.5); and combinations thereof.

4. The method according to claim 1, wherein the at least one flavor ingredient Fᵢⱼ has a clogP(Fᵢⱼ)from 1.51 to 2.5 and is selected from the group consisting of hydroxycitronellal (clogP=1.54); ethyl isobutyrate (clogP=1.55); methyl 2-methyl butyrate (clogP=1.55); 6-methyl-3,5-heptadien-2-one (clogP=1.55); (E)-2-hexenal (clogP=1.58); acetophenone (clogP=1.58); tetramethyl pyrazine (clogP=1.58); furfuryl mercaptan (clogP=1.59); (E)-2-hexenol (clogP=1.6); homofuronol (clogP=1.6); cinnamic alcohol (clogP=1.61); salicylic aldehyde (clogP=1.61); (e,e)-3,5-octadien-2-one (clogP=1.62); dihydrocoumarin (clogP=1.63); isobutyl acetate (clogP=1.64); (Z)-3-hexenoic acid (clogP=1.64); t(E)-3-hexenoic acid (clogP=1.64); furfuryl propionate (clogP=1.66); ethyl dimethyl pyrazine (clogP=1.66); 3-ethyl-2,(5 or 6)-dimethyl-pyrazine (clogP=1.66); 2-ethyl-3-methoxy-pyrazine (clogP=1.67); 2,4-heptadienal (clogP=1.68); 2-ethylbutanoic acid (clogP=1.70); 2-methylpentanoic acid (clogP=1.70); phenyl propyl alcohol (clogP=1.71); isoamyl formate (clogP=1.72); heliotropin (clogP=1.76); butyl acetate (clogP=1.77); ethyl butyrate (clogP=1.77); methyl valerate (clogP=1.77); anisyl aldehyde (clogP=1.78); cinnamic acid (clogP=1.78); furfuryl thioacetate (clogP=1.78); cinnamic acid (clogP=1.78); 4-methylpentanoic acid (clogP=1.79); phenyl acetaldehyde (clogP=1.78); 4-methylpentanoic acid (clogP=1.79); 2-methyl-4,5-dihydrofuran-3-thiol acetate (clogP=1.79); mint lactone (3,6-dimethyl-5,6,7,7a-tetrahydro-4H-1-benzofuran-2-one) (clogP=1.8); acetanisol (clogP=1.8); methoxy phenyl butanone (clogP=1.81); ethyl vanillin (clogP=1.81); linalool oxide (clogP=1.81); whiskey lactone (clogP=1.82); methyl heptenone (clogP=1.82); methyl phenyl acetate (clogP=1.82); methyl-6-hepten-5-one-2 (clogP=1.82); creosol (clogP=1.82); 2-(4-methylphenyl)ethanol (clogP=1.83); nonalactone gamma (clogP=1.83); amyl formate (clogP=1.85); ethyl crotonate (clogP=1.86); hydroxynonanoic acid, delta-lactone (clogP=1.86); nonalactone delta (clogP=1.86); phenyl-3-propanal (clogP=1.87); hexanol (clogP=1.88); anisyl acetate (clogP=1.88); 3-methyl-2-buten-1-yl acetate (clogP=1.88); hexan-1-ol (clogP=1.88); filbertone ((E)-5-methylhept-2-en-4-one) (clogP=1.88); benzoic acid (clogP=1.89); 2-ethylbutyraldehyde (clogP=1.89); hexanal (clogP=1.89); (Z)-3-hexenyl formate (clogP=1.9); heptanone-2 (clogP=1.91); jasmolactone ((E)-6-(pent-3-en-1-yl)tetrahydro-2H-pyran-2-one) (clogP=1.91); n-furfurylpyrrole (clogP=1.91); 3-heptanone (clogP=1.91); 1-hepten-3-ol (clogP=1.91); cresol ortho (clogP=1.92); hexanoic acid (clogP=1.92); piperonyl acetate (clogP=1.92); 1-butenyl-methyl sulfide (clogP=1.93); (E)-2-hexenoic (clogP=1.94); (Z)-4-heptenal (clogP=1.94); (z)-1,5-octadien-3-ol (clogP=1.95); benzyl acetate (clogP=1.96); (Z)-3-hexenyl lactate (clogP=1.96); trithia-2,3,5-hexane (clogP=1.96); cresol meta (clogP=1.97); diethyl-(2,5 +2,6) 3-methylpyrazine (clogP=1.97); 2-methoxycinnamic aldehyde (clogP=1.97); cresol para (clogP=1.97); para tolyl aldehyde (clogP=1.99); 4-methylphenyl acetate (clogP=1.99); 2-ethyl 4-methyl thiazole (clogP=2.01); methyl (Z)-3-hexenoate (clogP=2.01); prenyl ethyl ether (clogP=2.04); dimethyl benzyl carbinol (clogP=2.04); cinnamic aldehyde (clogP=2.05); methylphenethyl ether (clogP=2.05); methoxy-4-vinylphenol (clogP=2.05); furfuryl methyl sulfide (clogP=2.07); carvone laevo (clogP=2.08); ethyl 2-methylbutyrate (clogP=2.08); methyl acetophenone (clogP=2.08); benzothiazole (clogP=2.08); 2-methyl-1-propanethiol (clogP=2.1); oct-2-en-4-one (clogP=2.1); octen-3-one (clogP=2.1); oct-2-en-4-one (clogP=2.1); (E)-2-heptenal (clogP=2.11); methyl benzoate (clogP=2.11); methyl anthranilate (clogP=2.12); indole pure (clogP=2.13); benzylidene acetone (clogP=2.14); 1,3-dimethoxybenzene (clogP=2.15); dimethyl hydroquinone (clogP=2.15); ethyl tiglate (clogP=2.16); ethyl isovalerate (clogP=2.17); 5-ethyl-2-methylpyridine (clogP=2.17); isoamyl acetate (clogP=2.17); isobutyl propionate (clogP=2.17); methyl thiobenzoate (clogP=2.17); 2-methylbutyl acetate (clogP=2.17); 3-methyl-2,4-nonadione (clogP=2.18); fenchone (clogP=2.18); 3-methyl-2,4-nonadione (clogP=2.18); 2-heptanol (clogP=2.19); 4-vinylphenol (clogP=2.20); carvone (clogP=2.20); cyclohexyl acetate (clogP=2.21); 2,4-octadien-1-al (clogP=2.21); phenyl-2-butenal (clogP=2.21); butanethiol (clogP=2.23); styrallyl acetate (clogP=2.27); phenyl ethyl acetate (clogP=2.28); isophorone (clogP=2.28); methyl anisate (clogP=2.28); 2-heptanol (clogP=2.29); 3-methyl hexanal (clogP=2.29); ethyl valerate (clogP=2.3); methyl hexanoate (clogP=2.3); amyl acetate (clogP=2.3); propyl butyrate (clogP=2.3); eugenyl acetate (clogP=2.3); dihydro actinidiolide (clogP=2.32); methyl salicylate (clogP=2.33); campholenic aldehyde (clogP=2.34); (Z)-3-hexenyl-acetate (clogP=2.34); ethyl phenyl acetate (clogP=2.35); ethyl guaiacol para (clogP=2.35); decalactone gamma (clogP=2.36); 1-hexyl formate (clogP=2.38); 2-methyl-3 methylthiofuran (clogP=2.38); decalactone delta (clogP=2.39); 3-methyl-2-butanethiol (clogP=2.41); benzyl mercaptan (clogP=2.41); heptanol (clogP=2.41); 2-isopropyl-4-methylthiazole (clogP=2.41); 2,5-dimethyl phenol (clogP=2.42); 3,4-dimethylphenol (clogP=2.42); heptanal(clogP=2.42); methyl jasmonate (methyl 2-(3-oxo-2-pent-2-enylcyclopentyl)acetate) (clogP=2.43); ethyl phenyl glycidate (clogP=2.43); octen-1-ol-3 (clogP=2.43); octanone-2 (clogP=2.44); methyl hexyl ketone (clogP=2.44); 2-isobutyl thiazole (clogP=2.44); 3-octenol (clogP=2.44); heptanoic acid (clogP=2.45); para methyl benzyl acetate (clogP=2.46); methyl cinnamate (clogP=2.47); isobutyl isobutyrate (clogP=2.48); benzyl propionate (clogP=2.49); piperitone laevo (clogP=2.49); para ethyl phenol (clogP=2.5); and 3,6-nonadien-1-ol (clogP-2.5); and
combinations thereof.

5. The method according to claim 1, wherein the at least one flavor ingredient Fᵢⱼ has a clogP(Fᵢⱼ)from 2.51 to 3.5 and is selected from the group consisting of ethyl 3-hexenoate (clogP=2.54); (E)-2-hexenyl acetate (clogP=2.54); verbenone (clogP=2.55); cinnamyl acetate (clogP=2.55); cresyl methyl ether para (clogP=2.57); isoeugenol (clogP=2.58); 1-(4-methoxyphenyl)-1-penten-3-one (clogP=2.59); furfuryl isovalerate (clogP=2.59); isobutyl methoxy pyrazine (clogP=2.59); ethyl 2-methylpentanoate (clogP=2.61); carveol laevo (clogP=2.62); 3-nonen-2-one (clogP=2.63); terpineol alpha (clogP=2.63); 6-pentyl-2h-pyran-2-one (clogP=2.64); (E)-2-octenal (clogP=2.64); ethyl benzoate (clogP=2.64); jasmone-cis (clogP=2.64); ethyl anthranilate (clogP=2.65); (E)-2-octen-1-ol (clogP=2.65); phenyl propyl acetate (clogP=2.66); dimethyl anthranilate (clogP=2.66); isobutyl 3-methylthio butyrate (clogP=2.68); 2,6-nonadienal(clogP=2.68); 2,6-nonadienol (clogP=2.7); isobutyl butyrate (clogP=2.7); 2-isopropyl phenol (clogP=2.7); oct-3-enoic acid (clogP=2.7); methyl heptine carbonate (clogP=2.72); 2-octanol (clogP=2.72); 3-octanol (clogP=2.72); (E,E)-2,4-nonadienal (clogP=2.74); terpinen-4-ol (clogP=2.74); isoamyl propionate (clogP=2.74); iso-pulegol (clogP=2.75); linalool (clogP=2.75); 2-acetylnaphthone (clogP=2.76); isoamyl propionate (clogP=2.76); isobutyl 2-butenoate (clogP=2.78); methyl propyl disulfide (clogP=2.8); 1,4-cineole (clogP=2.81); para-ethyl anisate (clogP=2.81); 2-ethylhexanol (clogP=2.81); 6-methyl heptanal (clogP=2.82); butyl butyrate (clogP=2.82); eucalyptol (clogP=2.83); ethyl hexanoate (clogP=2.83); hexyl acetate (clogP=2.83); methyl heptanoate (clogP=2.83); menthone (clogP=2.83); frescomenthe (clogP=2.84); 6-methylheptanoic acid (clogP=2.85); ethyl salicylate (clogP=2.86); melonal (clogP=2.87); (Z)-3-hexenylpropionate (clogP=2.87); cuminic aldehyde (clogP=2.88); peach pure (5-heptyldihydrofuran-2(3H)-one) (clogP=2.89); butyl phthalide (clogP=2.9); 2-methyl-3-(para-methyl-phenyl)-propanal (clogP=2.9); ethyl (E)-2-hexenoate (clogP=2.91); undecalactone delta (clogP=2.92); safranal (clogP=2.93); octan-1-ol (clogP=2.94); citral (clogP=2.95); octanal (clogP=2.95); ethyl methyl phenyl glycidate (clogP=2.95); nonanone-2 (clogP=2.96); nerolex (clogP=2.97); geraniol (clogP=2.97); nerol (clogP=2.97); octanoic acid (clogP=2.98); (Z)-6-nonenol (clogP=2.98); dimethyl benzyl carbinyl acetate (clogP=2.99); ethyl cinnamate (clogP=2.99); (Z)-6-nonenal (clogP=2.99); isoamyl isobutyrate (clogP=3.01); 3-propylidene phthalide (clogP=3.01); benzyl butyrate (clogP=3.02); butyl butyro lactate (clogP=3.02); methyl eugenol-iso (clogP=3.05); allyl caproate (clogP=3.07); (Z)-4-decenal (clogP=3.09); 4-methyloctanoic acid (clogP=3.09); 3,5,5-trimethylhexanal (clogP=3.09); fenchyl alcohol (clogP=3.1); borneol (clogP=3.1); isobutyl isovalerate (clogP=3.1); iso borneol (clogP=3.1); isobutyl isovalerate (clogP=3.1); methyl dihydro jasmonate (clogP=3.1); vanitrope ((E)-2-ethoxy-5-(prop-1-en-1-yl)phenol) (clogP=3.11); phenyl ethyl isobutyrate (clogP=3.12); decen-2-one; 3-(clogP=3.16); (E)-2-nonenal (clogP=3.16); rose oxide (clogP=3.17); thymol (clogP=3.2); thymol crystals (clogP=3.2); 2-isopropyl-5-methylhexen-2-al (clogP=3.21); butyl isovalerate (clogP=3.23); methyl propyl trisulfide (clogP=3.23); 2-methylbutyl butyrate (clogP=3.23); isoamyl butyrate (clogP-3.23); menthol (clogP=3.23); methyl octyne carbonate (clogP=3.25); citronellol (clogP=3.25); citroxide (clogP=3.26); citronellal (clogP=3.26); 2,4-decadienal (clogP-3.27); isobutyl phenyl acetate (clogP=3.28); diallyl disulfide (clogP=3.29); dibenzyl ether (clogP=3.3); isopropyl cinnamate (clogP=3.3); piperine (clogP=3.31); anethol synthetic (clogP=3.31); phenyl ethyl butyrate (clogP=3.34); carvacrol (clogP=3.35); pentyl butyrate (clogP=3.36); hexyl propionate (clogP=3.36); ethyl heptanoate (clogP-3.36); heptyl acetate (clogP=3.36); methyl octanoate (clogP=3.36); propyl hexanoate (clogP=3.36); octenyl acetate (clogP=3.38); octenyl-3 acetate (clogP=3.38); lime oxide (clogP=3.39); (Z)-3-hexenyl butyrate (clogP=3.4); carvyl acetate (clogP-3.41); benzyl isovalerate (clogP-3.42); dodecalactone gamma (clogP=3.42); isoamyl isobutyrate (clogP=3.42); dodecalactone delta (clogP=3.45); nonanol (clogP=3.47); geranyl formate (clogP=3.47); nonanal (clogP-3.48); 2-decanone (clogP-3.49); and combinations thereof.

6. The method according to claim 1, wherein the at least one flavor ingredient Fᵢⱼ has a clogP(Fᵢⱼ)from 3.51 to 4.5 and is selected from the group consisting of nonanoic acid (clogP-3.51); isoamyl 2-methyl butyrate (clogP=3.53); butylidene phtalide (clogP=3.54); terpinyl acetate (clogP=3.58); benzyl phenyl acetate (clogP=3.59); 5-ethyl-4-methyl-2-(1-methylpropyl)-thiazoline (clogP=3.6); ethyl octenoate-3 (clogP=3.6); 2-heptanethiol (clogP=3.6); (E)-2-hexenyl butyrate (clogP=3.6); methyl 3-nonenoate (clogP=3.6); isopentyl isovalerate (clogP=3.63); 2-methylbutyl 3-methylbutanoate (clogP=3.63); nonadienyl acetate (clogP=3.65); methyl para-tert-butylphenylacetate (clogP=3.65); 3-octyl acetate (clogP=3.66); 5-methyl-2-phenyl-2-hexenal (clogP=3.66); (E)-2-decenal (clogP=3.69); dihydrocarvyl acetate (clogP=3.69); isopulegyl acetate (clogP=3.69); linalyl acetate (clogP=3.7); ionone alpha (clogP=3.71); (Z)-3-hexenyl 2-methylbutyrate (clogP=3.71); phenyl ethyl tiglate (clogP=3.73); phenyl ethyl isovalerate (clogP=3.74); pelargol (clogP=3.74); isobutyl hexanoate (clogP=3.75); 3-methyl-butyl valerate (clogP=3.75); citronellyl formate (clogP=3.75); naphthyl ethyl ether beta (clogP-3.76); ionone beta pure (clogP=3.77); bis(2-methyl-3-furyl) disulfide (clogP=3.79); menthen-9-yl acetate (clogP=3.79); (Z)-3-hexenyl isovalerate (clogP=3.8); menthyl lactate (clogP=3.8); 2,4-undecadienal (clogP=3.8); isoamyl phenylacetate (clogP=3.81); damascone alpha (clogP=3.82); cyclamen aldehyde (3-(4-isopropylphenyl)-2-methylpropanal) (clogP=3.83); para-cresyl phenyl acetate (clogP=3.84); octyl acetate(clogP=3.88); butyl hexanoate (clogP=3.88); octyl acetate (clogP=3.88); ethyl octanoate (clogP=3.88); hexyl butyrate (clogP=3.88); 4-ethyloctanoic acid (clogP=3.91); 4-methylnonanoic acid (clogP=3.91); neryl acetate (clogP=3.92); phenyl ethyl phenyl acetate (clogP=3.92); geranyl acetate (clogP=3.92); 2-pentylfuran (clogP=3.93); pentyl phenyl acetate (clogP=3.94); benzyl benzoate (clogP=3.94); ethyl 3-octenoate(clogP=3.97); methyl 2-nonenoate(clogP-3.97); decanol (clogP=4); decanal (clogP=4.01); cinnamyl isovalerate (clogP=4.01); methyl nonyl ketone (clogP-4.02); 2-undecanone (clogP=4.02); dimethyl benzyl carbinyl butyrate (clogP=4.04); isobornyl acetate (clogP=4.04); dihydroionone beta (clogP=4.04); bornyl acetate (clogP=4.05); 9-decenoic acid (clogP=4.05); cymene para (clogP=4.07); methyl alpha-ionone (clogP=4.07); allyl cyclohexyl propionate (clogP=4.14); nootkatone (clogP=4.15); benzyl salicylate (clogP=4.16); menthyl acetate pure (clogP=4.17); (Z)-3-hexenyl (Z)-3-hexenoate (clogP=4.18); hexyl 2-methylbutyrate (clogP=4.19); citronellyl acetate (clogP=4.2); phenyl acetaldehyde di isobutyl acetal (clogP-4.21); 2-undecenal (clogP=4.22); irone alpha (clogP=4.23); benzyl cinnamate (clogP=4.23); diphenyl oxide (clogP=4.24); damascenone (clogP=4.27); (Z)-3-hexenyl benzoate (clogP=4.27); isoamyl hexanoate (clogP-4.28); dihydronootkatone (clogP=4.3); ocimene (clogP=4.33); delta-3 carene (clogP=4.33); myrcene (clogP=4.33) limonene (clogP=4.35); terpinene gamma (clogP=4.35); terpinolene (clogP=4.35); thiogeraniol (clogP=4.38); phellandrene (clogP=4.41); ethyl nonanoate (clogP=4.41); nonyl acetate (clogP=4.41); amyl hexanoate (clogP=4.41); terpinene alpha (clogP=4.41); ethyl pelargonate (clogP=4.41); neryl propionate (clogP=4.44); geranyl propionate (clogP=4.44); isoamyl cinnamate (clogP=4.45); isoamyl salicylate (clogP=4.45); ethyl-4-decenoate (clogP=4.46); (Z)-3-hexenyl hexanoate (clogP=4.46); and amyl cinnamic aldehyde (clogP=4.47); and combinations thereof.

7. The method according to claim 1, wherein the at least one flavor ingredient Fᵢⱼ has a clogP(Fᵢⱼ)of 4.51 and above and is selected from the group consisting of delta-tetradecalactone (clogP=4.51); cedrol (clogP=4.53); linalyl isobutyrate (clogP=4.53); undecanal (clogP=4.54); phenyl ethyl cinnamate (clogP=4.56); ethyl decadienoate (clogP=4.61); ethyl 2,4-decadienoate ((2E,4Z)-ethyl deca-2,4-dienoate) (clogP=4.61); terpinyl butyrate (clogP=4.63); octen-1-yl butanoate (clogP=4.66); dodecanoic acid (clogP=4.67); damascone beta (clogP=4.69); pinene alpha (clogP=4.7); camphene (clogP=4.7); pinene beta (clogP=4.7); octyl iso butyrate (clogP=4.72); citronellyl propionate (clogP=4.73); caryophyllene oxide (clogP=4.74); linalyl butyrate (clogP=4.75); dodecenal (clogP=4.75); nerolidol (clogP=4.78); cinnamyl cinnamate (clogP=4.84); 2-hexyl thiophene (clogP=4.93); decyl acetate (clogP=4.94); ethyl decylate (clogP=4.96); ethyl decanoate (clogP=4.96); hexyl hexanoate (clogP=4.96); geranyl butyrate (clogP=4.97); farnesol (clogP=5); ethyl-(E)-2-decenoate (clogP=5.03); citronellyl butyrate-iso (clogP=5.04); dodecan-1-ol (clogP=5.05); dodecanalc (clogP=5.07); undecatriene (clogP=5.15); linalyl isovalerate (clogP-4.535.15); geranyl isovalerate (clogP=5.17); citronellyl butyrate (clogP=5.25); (E)-2-tridecenal (clogP=5.28); isoamyl octanoate (clogP=5.34); thibetolide (clogP=5.35); ambrettolide (clogP=5.42); ambrofix (clogP=5.47); linalyl benzoate (clogP=5.62); dodecyl acetate (clogP=6); butyl undecylenate (clogP=6.05); valencene (clogP-6.3); farnesene (clogP-6.36); bisabolene (clogP=6.38); caryophyllene (clogP=6.45); and combinations thereof.

8. The method according to claim 1, wherein the vapor pressure of the flavor ingredient Fᵢⱼ is equal to or less than the vapor pressure of the off-odor component Oᵢ.

9. The method according to claim 1, wherein the vapor pressure of the flavor ingredient Fᵢⱼ is equal to or higher than the vapor pressure of the off-odor component Oᵢ.

10. The method according to claim 1, wherein the odor strength of the flavor ingredient Fᵢⱼ is equal to or higher than the odor strength of the off-odor component Oᵢ.

11. The method according to claim 1, wherein the flavor ingredient Fᵢⱼ has an olfactive profile that is compatible with the olfactive profile of the flavored food or beverage product to which the flavor ingredient Fᵢⱼ is added.

12. The method according to claim 1, wherein the flavor ingredient Fᵢⱼ has an odor strength, at the level flavor ingredient is used in the food or beverage product, that is equal to or higher than the odor strength of the off-note component Oᵢ.

13. The method according to claim 1, wherein the flavor ingredient Fᵢⱼ has an olfactive profile compatible with the olfactive profile of the food or beverage product.

14. The method according to claim 1, wherein the flavor ingredient Fᵢⱼ is selected from the group consisting of CHO compounds, in particular aldehydes, alcohols, esters, lactones, ketones, ethers ketals, acids O-heterocycles; and combinations thereof.

15. A food or beverage product selected from savory products, dairy products, beverages, carbonated beverages, and/or energy drinks, prepared by the method according to claim 1.

16. The food or beverage product according to claim 15, comprising fish oil and a vanilla flavor comprising delta-nonalactone and creosol.

17. A flavor composition comprising from 0.000001 wt.-% to 100 wt.-%, of the at least one flavor ingredient Fᵢⱼ of claim 1, based on the total weight of the odor active flavor ingredients comprised in the flavor composition.

18. A method of mitigating off-odors in a flavored food or beverage product caused by one or more off-odor components Oᵢ, the method comprising adding to the flavored food or beverage product an effective amount of at least one flavor ingredient Fᵢⱼ, the clogP value of the at least one flavor ingredient Fᵢⱼ, (clogP(Fᵢⱼ)), being close to that of the one or more off odor component Oᵢ, (clogP(Oᵢ)) by less than ±0.75.

19. The method of claim 18, wherein the one or more off-odor components Oᵢ is an off-odor component derived from fish oil.

20. the method of claim 19, wherein the fish oil comprises at least one of docosahexaenoic acid (DHA), alpha-linolenic acid (ALA), or eicosapentaenoic acid (EPA).
